(19) United States
(12) Patent Application Publication
(10) Pub. No.: US 2007/0027062 A1
(43) Pub. Date: Feb. 1, 2007

(54) 4-Methyldec-4-en-3-ol and fragrance composition

(75) Inventors: Katja Berg-Schultz, Kaiseraugst (CH); Jerzy A. Bajgrowicz, Zurich (CH); Josianne Baudin, Annemasse (FR)

Correspondence Address: NORRIS, MCLAUGHLIN & MARCUS, 875 THIRD AVE, 18TH FLOOR, NEW YORK, NY, 10022, US

(73) Assignee: Givaudan SA, Vernier (CH)

(21) Appl. No.: 10/571,660

(22) PCT Filed: Sep. 10, 2004
(86) PCT No.: PCT/CH04/00570

§ 371 Date: Mar. 10, 2006

(51) Int. Cl. A61Q 13/00

(52) U.S. Cl. 512/25

(57) ABSTRACT

The invention is related 4-methyldec-4-en-3-ol and its use as fragrance ingredient.

The present invention refers to 4-methyldec-4-en-3-ol, to a method of its production and to fragrance compositions comprising it.

In the fragrance industry there is a constant demand for new compounds that enhance or improve on odour notes, or impart new odour notes.

Compounds enhancing floral, fruity, green odour notes are of particular interest, because of the general trend of return to classical natural scents. Surprisingly we found that 4-methyldec-4-en-3-ol fulfils this demand.

Thus, the present invention refers in one of its aspects to the use of 4-methyldec-4-en-3-ol as fragrance.

4-Methyldec-4-en-3-ol may be used alone or in combination with a base material. As used herein, the “base material” includes all known odourant molecules selected from the extensive range of natural products and synthetic molecules currently available, such as essential oils, alcohols, aldehydes and ketones, ethers and acetals, esters and lactones, macrocycles and heterocycles, and/or in admixture with one or more ingredients or excipients conventionally used in conjunction with odourants in fragrance compositions, for example, carrier materials, and other auxiliary agents commonly used in the art.

The following list comprises examples of known odourant molecules, which may be combined with the compounds of the present invention:

ethereal oils and extracts, e.g. tree moss absolute, basil oil, castoreum, costus root oil, myrtle oil, oak moss absolute, geranium oil, jasmin absolute, patchouli oil, rose oil, sandalwood oil, wormwood oil, lavender oil or ylang-ylang oil;

alkohols, e.g. citronellol, Ebanol™, eugenol, farnesol, geraniol, Super Muguet™, linalool, phenylethyl alcohol, Sandalore™, terpineol or Timberol™.

aldehydes and ketones, e.g. α-amylcinnamaldehyde, Georgywood™, hydroxycitronellal, iso E Super®, Isoraldeine®, Hedione®, maltol, Methyl cedryl ketone, methylionone or vanillin;

ethers and acetals; e.g. Ambrox™, geranyl methyl ether, rose oxide or Spirambrene™.

esters and lactones, e.g. benzyl acetate, Cedryl acetate, γ-decalactone, Helvetolide®, γ-undecalactone or Vetivenyl acetate.

macrocycles, e.g. Ambrettolide, Ethylene brassylate or Exaltolide®.

heterocycles, e.g. isobutylchinoline.

The compound of the present invention may be used in a broad range of fragrance applications, e.g. in any field of fine and functional perfumery, such as perfumes, household products, laundry products, body care products and cosmetics. The compound can be employed in widely varying amounts, depending upon the specific application and on the nature and quantity of other odourant ingredients. The proportion is typically from 0.001 to 20 weight percent of the application. In one embodiment, 4-methyldec-4-en-3-ol may be employed in a fabric softener in an amount of from 0.001 to 0.05 weight percent. In another embodiment, 4-methyldec-4-en-3-ol may be used in fine perfumery in amounts of from 0.1 to 20 weight percent, more preferably between 0.1 and 5 weight percent. However, these values are given only by way of example, since the experienced perfumer may also achieve effects or may create novel accords with lower or higher concentrations.

The compound of the present invention may be employed into the fragrance application simply by directly mixing the fragrance composition with the fragrance application, or they may, in an earlier step be entrapped with an entrapment material, for example, polymers, capsules, microcapsules and nanocapsules, liposomes, film formers, absorbents such as carbon or zeolites, cyclic oligosaccharides and mixtures thereof, or they may be chemically bonded to substrates, which are adapted to release 4-methyldec-4-en-3-ol upon application of an extemarn stimulus such as light, enzyme, or the like, and then mixed with the application.

Thus, the invention additionally provides a method of manufacturing a fragrance application, comprising the incorporation of 4-methyldec-4-en-3-ol as a fragrance ingredient, either by directly admixing it to the application or by admixing a fragrance composition comprising 4-methyldec-4-en-3-ol, which may then be mixed to a fragrance application, using conventional techniques and methods.

As used herein, “fragrance application” means any product, such as fine perfumery, e.g. perfume and eau de toilette; household products, e.g. detergents for dishwasher, surface cleaner; laundry products, e.g. softener, bleach, detergent; body care products, e.g. shampoo, shower gel; and cosmetics, e.g. deodorant, vanishing creme, comprising an odourant. This list of products is given by way of illustration and is not to be regarded as being in any way limiting.

4-Methyldec-4-en-3-ol may be prepared for example by alkylation of 2-methylnon-2-enal in the presence of ethylmagnesium bromide according to the procedure described in example 1.

### EXAMPLE 1

### 4-Methyldec-4-en-3-ol

A solution of 2-methylnon-2-enal (2.7 g, 19 mmol) in diethyl ether (10 ml) was slowly added, under nitrogen, to a 3M solution of ethylmagnesium bromide in diethyl ether (7.0 ml, 21 mmol) diluted with the same solvent (10 ml) at 0-5° C., under nitrogen. The reaction mixture was stirred at room temperature for 24 h, poured on an ice-cold 2N HCl solution and extracted with MTBE (100 ml). The combined organic layers were washed with brine (2×100 ml), dried (MgSO₄) and concentrated in vacuo. The crude product (1.8 g, 55% yield) was purified by flash chromatography (silica gel; n-hexane/MTBE 4:1) to provide an olfactorily pure sample. B.p. 99° C./10 mbar.

¹H-NMR (400 MHz, in CDCl₃): δ0.82 (t, J=7.5, 3H), 0.89 (t, J=7.0, 3H), 1.22-1.42 (m, 6H), 1.53 (m, 2H), 1.56 (s, 3H), 2.01 (q, J=7.2, 2H), 2.73 (s, 1H), 3.85 (t, J=6.8, 1H), 5.34 (t, J=7.2, 1H). ¹³C NMR (100 MHz, in CDCl₃): δ9.9 (q), 10.7 (q), 13.8 (q), 22.4 (t), 27.3 (t), 27.4 (t), 29.1 (t), 31.4 (t), 79.2 (d), 126.6 (d), 136.7 (s). IR (neat): λₘₐₓ 3356, 2959, 2929, 2873, 2858, 1458, 1335, 1099, 1002, 963 cm⁻¹.

Odour description: Floral, rosy, fatty, fresh, metallic, green.

### EXAMPLE 2

### Fragrance Composition for a Soap

| Ingredient | Part per weight |
|---|---|
| Agrumex | 15 |
| 4-t-Butylcyclohexyl acetate | 50 |
| Carbitol | 302 |
| p-Cresol | 12 |
| Damascenone 1% in DPG | 15 |
| Damascone delta 1% in DPG | 20 |
| Ethyl maltol | 2 |
| Fructone | 10 |
| Heliotropin | 10 |
| Hydroxycitronellal | 20 |
| 4-(p-Hydroxyphenyl)-2-butanone | 5 |
| Ionone beta | 300 |
| Iso E Super | 50 |
| Lilial | 20 |
| Linalool | 40 |
| Methylionone | 500 |
| Neofolione | 10 |
| Nonadienal 10% in TEC | 2 |
| Sandela | 50 |
| Terpenyl acetate | 20 |
| p-Tolulaldehyde | 2 |
| Vaniline | 5 |
| Verdyl acetate | 20 |
| 4-Methyldec-4-en-3-ol | 20 |
| | 1500 |

4-Methyldec-4-en-3-ol makes this composition smell rounder, richer, more creamy and fruity, giving it a green natural touch.

1. 4-Methyldec-4-en-3-ol.

2. The use of 4-methyldec-4-en-3-ol as fragrance ingredient.

3. A fragrance composition comprising 4-methyldec-4-en-3-ol.

4. A method of manufacturing a fragrance application, comprising the step of incorporating 4-methyldec-4-en-3-ol.
